(19) United States
(12) Patent Application Publication
(10) Pub. No.: US 2012/0255508 A1
(43) Pub. Date: Oct. 11, 2012

(54) Valve Lifter of Internal Combustion Engine and Method of Fabricating the Valve Lifter

(75) Inventors: Atsushi TACHIBANA, Hadano-shi (JP); Noriomi Hosaka, Hiratsuka-shi (JP); Tomoya Tanaka, Atsugi-shi (JP); Tetsuo Yamazaki, Atsugi-shi (JP); Kinichi Hashimoto, Yamato-shi (JP)

(73) Assignee: Hitachi Automotive Systems, Ltd., Hitachinaka-shi (JP)

(21) Appl. No.: 13/441,162

(22) Filed: Apr. 6, 2012

(30) Foreign Application Priority Data
Apr. 8, 2011 (JP) 2011-085956

(51) Int. Cl. F01L 1/053; B23P 15/00

(52) U.S. Cl. 123/90.6; 29/888.08

(57) ABSTRACT

A valve lifter including a cylindrical portion, a crown portion having a crown surface, a chamfered portion formed on an outer periphery of the crown portion adjacent to an outer peripheral edge of the crown surface and tapered toward the crown surface, and a hard carbon film covering only the crown surface and the chamfered portion. The chamfered portion has a taper angle with respect to an outer peripheral surface of the cylindrical portion on which the hard carbon film is not formed, the taper angle being set to not more than 26.5°. The chamfered portion has a length extending from on a side of the crown surface toward a side of the cylindrical portion in an axial direction of the cylindrical portion, the length being set to not less than 1 mm.

### BACKGROUND OF THE INVENTION

The present invention relates to a valve lifter of an internal combustion engine and a method of fabricating the valve lifter.

Japanese Patent Application Unexamined Publication No. 2006-144100 discloses a valve lifter of an internal combustion engine. The valve lifter is disposed between a stem end of an intake valve and a rotating cam provided on a cam shaft. The valve lifter includes a cylindrical portion slidable on an inner peripheral surface of a lifter bore of a cylinder head, and a crown portion that is integrally formed with an upper end portion of the cylindrical portion and has a crown surface on which the rotating cam rolls. The crown surface on which high pressure is exerted is formed with a hard carbon film such as a so-called diamond-like carbon (DLC) film in order to reduce friction and wear which are caused on the crown surface.

Such a valve lifter is subjected to formation of the hard carbon film on the crown surface by a given method. Subsequently, a whole outer peripheral surface of the cylindrical portion and the crown portion is subjected to finish polishing with a grind stone or the like, so that a dimensional accuracy of an outer diameter of the valve lifter can be enhanced.

However, in the valve lifter of the conventional art, when the hard carbon film is formed on the crown surface, the hard carbon film extends beyond an outer peripheral edge of the crown surface along an axial direction of the cylindrical portion, that is, wraps around the outer peripheral edge of the crown surface to reach the outer peripheral surface of the crown portion, i.e., an upper edge of the outer peripheral surface of the cylindrical portion, and then adheres and solidifies thereon.

The hard carbon film has a hardness higher than the grind stone used for finish-polishing. Therefore, when the outer peripheral surface of the crown portion is polished with the grind stone, the grind stone is worn at a polishing part thereof so that life of the grind stone will be reduced. Further, there will occur such a technological problem that the grind stone is clogged with a powder of the polished hard carbon film, thereby causing polishing deficiency.

The present invention was made in consideration of the above-described problems in the technology of the conventional art. An object of the present invention is to provide a valve lifter capable of suppressing reduction of life of the grind stone and occurrence of clogging of the grind stone, and a method of fabricating the valve lifter.

According to the present invention, in a case where an outer peripheral surface of a valve lifter having a hard carbon film on a crown surface thereof is subjected to polishing, it is possible to suppress reduction of life of the grind stone and occurrence of clogging of the grind stone.

The other objects and features of this invention will become understood from the following description with reference to the accompanying drawings.

In a first aspect of the present invention, there is provided a valve lifter of an internal combustion engine, including:
a cylindrical portion slidably moveable in a bore formed in the internal combustion engine;
a crown portion formed on one axial end portion of the cylindrical portion and integrally formed therewith, the crown portion having a crown surface that is contacted with a cam of the internal combustion engine,
a chamfered portion formed on an outer periphery of the crown portion adjacent to an outer peripheral edge of the crown surface, the chamfered portion being tapered toward the crown surface, and
a hard carbon film formed on the crown portion so as to cover only the crown surface and the chamfered portion;
wherein the chamfered portion has a taper angle with respect to an outer peripheral surface of the cylindrical portion on which the hard carbon film is not formed, the taper angle being set to not more than 26.5°, and
wherein the chamfered portion has a length extending from on a side of the crown surface toward a side of the cylindrical portion in an axial direction of the cylindrical portion, the length being set to not less than 1 mm.

In a second aspect of the present invention, there is provided the valve lifter according to the first aspect, wherein the taper angle of the chamfered portion is set to not less than 1°.

In a third aspect of the present invention, there is provided the valve lifter according to the first aspect, wherein the chamfered portion has a maximum depth on a side of the crown surface which extends outwardly in a radial direction of the crown surface, the maximum depth being set to not more than 0.5 mm.

In a fourth aspect of the present invention, there is provided the valve lifter according to the first aspect, wherein the hard carbon film has a thickness of 0.5 μm to 3.0 μm.

In a fifth aspect of the present invention, there is provided the valve lifter according to the first aspect, wherein the hard carbon film is a diamond-like carbon coating film.

In a sixth aspect of the present invention, there is provided a valve lifter of an internal combustion engine, including:
a cylindrical portion slidably moveable in a bore formed in the internal combustion engine;
a crown portion formed on one axial end portion of the cylindrical portion and integrally formed therewith, the crown portion having a crown surface that is contacted with a cam of the internal combustion engine,
a chamfered portion formed on an outer periphery of the crown portion adjacent to an outer peripheral edge of the crown surface, the chamfered portion being tapered toward the crown surface, and
a hard carbon film formed on the crown portion so as to cover only the crown surface and the chamfered portion;
wherein an outer peripheral surface of the hard carbon film covering the chamfered portion is located in a plane that contains an extension line extending from an outer peripheral surface of the cylindrical portion in an axial direction of the cylindrical portion, or located offset from the plane inwardly in a radial direction of the cylindrical portion, and
wherein the outer peripheral surface of the hard carbon film covering the chamfered portion is a non-polished surface.

In a seventh aspect of the present invention, there is provided the valve lifter according to the sixth aspect, wherein a whole area of the outer peripheral surface of the hard carbon film covering the chamfered portion is non-polished.

In an eighth aspect of the present invention, there is provided the valve lifter according to the seventh aspect, wherein the chamfered portion has a taper angle with respect to the outer peripheral surface of the cylindrical portion on which the hard carbon film is not formed, the taper angle being set to not more than 26.5°.

In a ninth aspect of the present invention, there is provided the valve lifter according to the eighth aspect, wherein the chamfered portion has a length extending toward a side of the cylindrical portion in the axial direction of the cylindrical portion, the length being set to not less than 1 mm.

In a tenth aspect of the present invention, there is provided the valve lifter according to the ninth aspect, wherein the chamfered portion has a maximum depth on a side of the crown surface which extends outwardly in a radial direction of the crown surface, the maximum depth being set to not more than 0.5 mm.

In an eleventh aspect of the present invention, there is provided the valve lifter according to the seventh aspect, wherein the hard carbon film has a thickness of 0.5 μm to 3.0 μm.

In a twelfth aspect of the present invention, there is provided the valve lifter according to the seventh aspect, wherein the hard carbon film is a diamond-like carbon coating film.

In a thirteenth aspect of the present invention, there is provided a method of fabricating a valve lifter of an internal combustion engine, the valve lifter including a cylindrical portion slidably moveable in a bore formed in the internal combustion engine, and a crown portion formed on one axial end portion of the cylindrical portion and integrally formed therewith, the crown portion having a crown surface that is contacted with a cam of the internal combustion engine, the method including the steps of:
after integrally forming the cylindrical portion and the crown portion, forming a chamfered portion on an outer periphery of the crown portion adjacent to an outer peripheral edge of the crown surface such that the chamfered portion has a taper angle of not more than 26.5° with respect to an outer peripheral surface of the cylindrical portion and a length of not less than 1 mm which extends toward a side of the cylindrical portion in an axial direction of the cylindrical portion;
forming a hard carbon film by allowing carbon particles to deposit toward the crown surface under a condition that the outer peripheral surface of the crown portion is covered with a masking jig; and
subjecting the outer peripheral surface of the cylindrical portion to polishing.

In a fourteenth aspect of the present invention, there is provided the method of fabricating a valve lifter according to the thirteenth aspect, wherein the step of polishing the outer peripheral surface of the cylindrical portion is conducted with a grind stone.

In a fifteenth aspect of the present invention, there is provided the method of fabricating a valve lifter according to the fourteenth aspect, wherein the grind stone is held in non-contact with at least an outer peripheral surface of the hard carbon film covering the chamfered portion during the step of polishing the outer peripheral surface of the cylindrical portion.

In a sixteenth aspect of the present invention, there is provided the method of fabricating a valve lifter according to the fifteenth aspect, wherein the grind stone is held in non-contact with the hard carbon film during the step of polishing the outer peripheral surface of the cylindrical portion.

### BRIEF DESCRIPTION OF THE DRAWINGS

FIG. 1 is a schematic section of an essential part of an internal combustion engine to which a valve lifter according to an embodiment of the present invention is applied.

FIG. 2 is a vertical cross section of a substrate as a molding before being formed into the valve lifter according to the embodiment of the present invention.

FIG. 3 is an enlarged diagram showing portion A as shown in FIG. 2.

FIG. 4 is an explanatory diagram showing a step of finish-polishing an outer peripheral surface of the substrate on which a diamond-like carbon (DLC) coating film is formed.

FIG. 5 is an enlarged vertical cross section of an essential part of the valve lifter obtained after subjecting the outer peripheral surface of the substrate as shown in FIG. 4 to finish-polishing.

FIG. 6 is an explanatory diagram showing a step of allowing carbon particles of DLC to deposit toward the crown surface of the substrate.

FIG. 7 is a graph showing a relationship between thickness of a portion of the DLC coating film formed on a chamfered portion of the valve lifter and distance of the portion from the crown surface.

FIG. 8A is an explanatory diagram showing a relationship between inclination angle of the valve lifter within a guide bore and the chamfered portion of the valve lifter.

FIG. 8B is a schematic diagram of FIG. 8A.

### DETAILED DESCRIPTION OF THE INVENTION

An embodiment of a valve lifter of an internal combustion engine and a method of fabricating the valve lifter, according to the present invention, will be described in detail hereinafter by referring to the accompanying drawings. In the embodiment, the slide member is used as a valve lifter in an internal combustion engine, which has a slide surface slidable relative to a cam so as to open and close an engine valve of the internal combustion engine. For ease of understanding, various directional terms, directional terms such as “upper”, “lower”, “upward”, “downward”, etc. are used in the following description, but merely denote directions as viewed in the drawings.

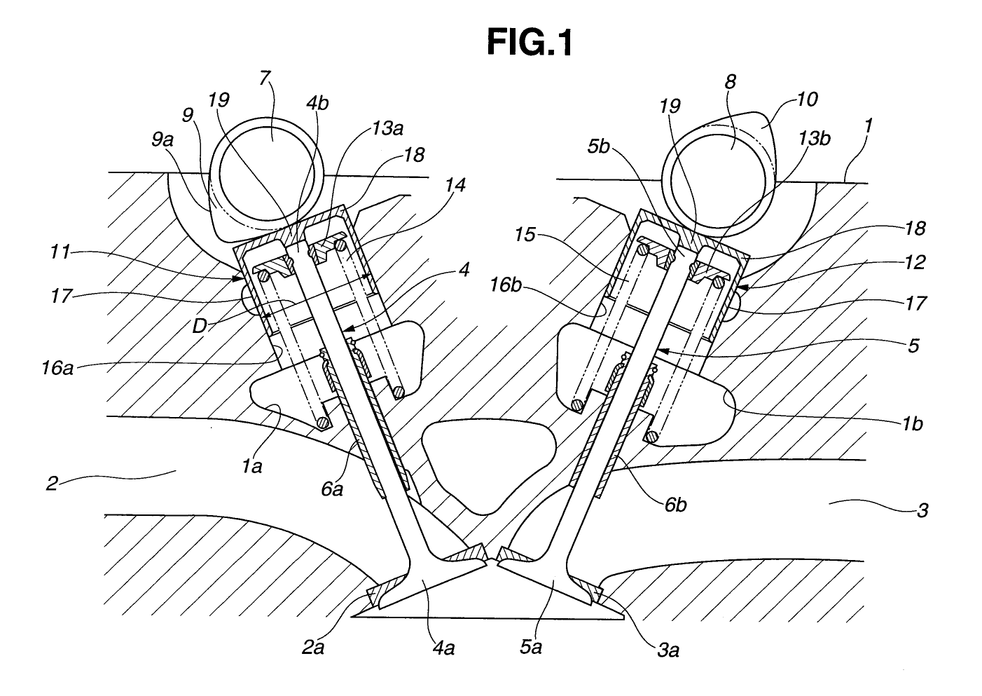

Referring to FIG. 1 to FIG. 8, the valve lifter according to the embodiment of the present invention is explained. The valve lifter according to the embodiment may be applied to an intake side and an exhaust side of a four-cylinder four-cycle gasoline engine.

In FIG. 1, the intake side is indicated on the left side, and the exhaust side is indicated on the right side. As shown in FIG. 1, two engine valves per cylinder, i.e., intake valve 4 and exhaust valve 5, are respectively slidably disposed in cylinder head 1 through valve guides 6a, 6b so as to open and close combustion chamber-side open ends of intake port 2 and exhaust port 3 which are formed in cylinder head 1. Intake-side and exhaust-side camshafts 7, 8 are rotatably supported on an upper end portion of cylinder head 1 through a cam bearing. Drive cams 9, 10 which respectively allow intake valve 4 and exhaust valve 5 to open are integrally formed on outer peripheries of intake-side and exhaust-side camshafts 7, 8.

Intake valve 4 has head 4a on a lower end portion of a valve stem thereof. Head 4a is seated onto and unseated from annular valve seat 2a formed on the open end of intake port 2. Spring retainer 13a is fixed to upper stem end portion 4b of intake valve 4. Valve spring 14 is installed between spring retainer 13a and a bottom surface of support hole 1a formed in an upper end portion of cylinder head 1. Intake valve 4 is biased in a closing direction thereof by a biasing force of valve spring 14. Exhaust valve 5 has head 5a on a lower end portion of a valve stem thereof. Head 5a is seated onto and unseated from annular valve seat 3a formed on the open end of exhaust port 3. Spring retainer 13b is fixed to upper stem end portion 5b of exhaust valve 5. Valve spring 15 is installed between spring retainer 13b and a bottom surface of support hole 1b formed in the upper end portion of cylinder head 1. Exhaust valve 5 is biased in a closing direction thereof by a biasing force of valve spring 15.

As shown in FIG. 1, respective drive cams 9, 10 are of a generally known type, and formed into an oval shape in side view, having a predetermined width.

Valve lifter 11 is disposed between intake valve 4 and drive cam 9. Valve lifter 12 is disposed between exhaust valve 5 and drive cam 10.

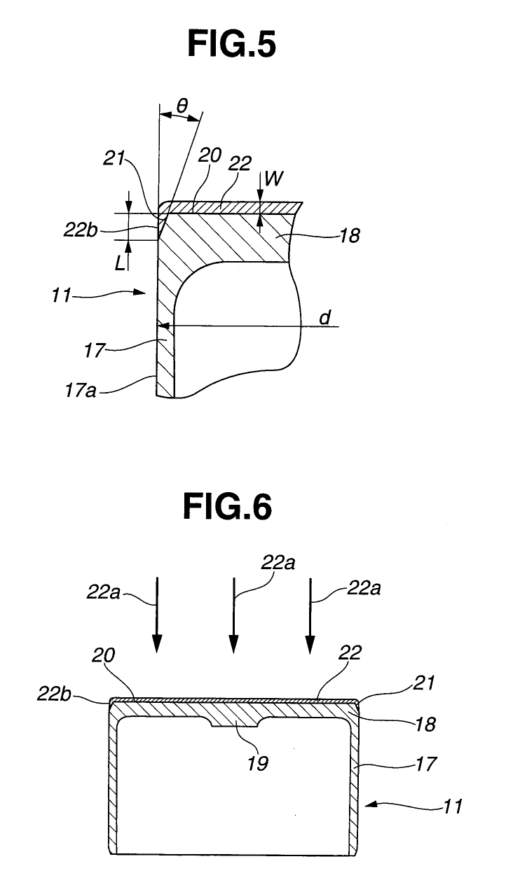

Each of valve lifters 11, 12 is a direct acting valve lifter, and formed into an integral body made of carbon steel as iron-based metal. As shown in FIG. 1, valve lifters 11, 12 include skirt portions 17, 17, crown portions 18, 18 and boss portions 19, 19. Skirt portions 17, 17 are cylindrical portions respectively held to be upwardly and downwardly slidable in guide bores 16a, 16b which are formed in the upper end portion of cylinder head 1. Crown portions 18, 18 are integrally formed with axial end portions (i.e., upper end portions) of skirt portions 17, 17. Crown portions 18, 18 are covered with hard carbon films 22 (see FIG. 5) as explained in detail later. Boss portions 19, 19 are disposed in a substantially central position of a lower surface of respective crown portions 18, 18, and integrally formed with respective crown portions 18, 18. Boss portions 19, 19 are respectively contacted with upper stem end portion 4b of intake valve 4 and upper stem end portion 5b of exhaust valve 5.

Thus, valve lifter 11 on the intake side and valve lifter 12 on the exhaust side have same construction. Therefore, for the sake of convenience, only valve lifter 11 on the intake side according to the embodiment of the present invention will be explained in detail hereinafter.

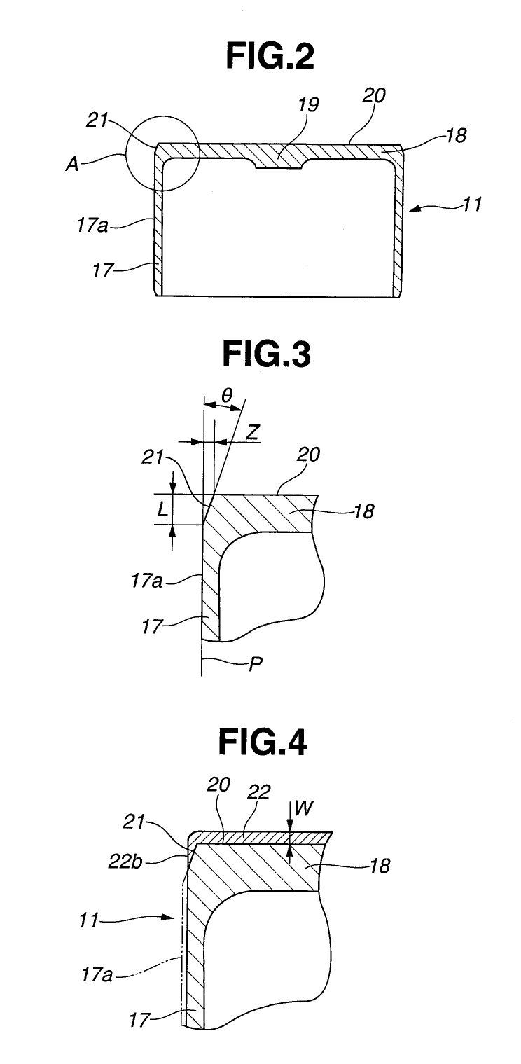

FIG. 2 is a vertical cross section of a substrate as a molding before being formed into valve lifter 11 as partially shown in FIG. 5. As shown in FIG. 2, skirt portion 17 of valve lifter 11 is formed into a hollow generally cylindrical shape, and has a small wall thickness. Valve lifter 11 is slidably moved on an inner peripheral surface of guide bore 16a of cylinder head 1 with a predetermined friction that is generated between outer peripheral surface 17a of skirt portion 17 and the inner peripheral surface of guide bore 16a.

Crown portion 18 of valve lifter 11 has a generally disk shape and a relatively large wall thickness. Crown portion 18 has circular crown surface 20 on an upper end thereof with which outer peripheral surface 9a of drive cam 9 is slidably contacted via hard carbon film 22 (see FIG. 5).

As shown in FIG. 3, chamfered portion 21 is formed on an outer periphery of crown portion 18 adjacent to an outer peripheral edge (an outer peripheral end) of crown surface 20. Chamfered portion 21 extends in an axial direction of skirt portion 17, and is tapered toward crown surface 20. Chamfered portion 21 is provided in order to reduce large friction that occurs in a case where a valve lifter having no chamfered portion slides on the inner peripheral surface of guide bore 16a in an inclined state relative to the inner peripheral surface of guide bore 16a. Such large friction is caused due to slide contact between the inner peripheral surface of guide bore 16a and a corner portion (a substantially acute angled corner portion) of the valve lifter at which the crown surface and an outer peripheral surface of the crown portion encounter with each other.

Chamfered portion 21 has a predetermined size, i.e., taper angle θ, length L and depth Z as shown in FIG. 3. Specifically, as shown in FIG. 3, chamfered portion 21 has taper angle θ with respect to outer peripheral surface 17a of skirt portion 17 which extends along the axial direction of skirt portion 17. The taper angle θ is set within a range of not less than about 1° and not more than about 26.5°. Further, as shown in FIG. 5, chamfered portion 21 has length (distance) L which extends from an upper end of chamfered portion 21 (i.e., crown surface 20) in the axial direction of skirt portion 17. The length L is set to about 1 mm or more. In this embodiment, the taper angle θ is set to about 26.5°, and the length L is set to about 1 mm. Further, as shown in FIG. 3, chamfered portion 21 has maximum depth Z on a side of crown surface 20 which extends outwardly in a radial direction of crown surface 20. That is, the maximum depth Z is a distance extending between the outer peripheral edge of crown surface 20 and plane P containing an extension line that extends from outer peripheral surface 17a of skirt portion 17 in the axial direction of skirt portion 17. The maximum depth Z is set within a range of from 0.02 mm to 0.5 mm. In this embodiment, the maximum depth Z is set to about 0.5 mm.

As shown in FIG. 4 and FIG. 5, hard carbon film 22 is formed on crown portion 18 over the whole area of crown surface 20 and chamfered portion 21. Hard carbon film 22 is formed by a so-called diamond-like carbon (DLC) coating treatment as a generally known surface treatment. That is, crown surface 20 and chamfered portion 21 are covered with DLC coating film 22 having high hardness and low friction resistance. An outer surface of hard carbon film 22 covering chamfered portion 21 is located in plane P containing the extension line extending from outer peripheral surface 17a of skirt portion 17 in the axial direction of skirt portion 17, or located offset from the plane P inwardly in a radial direction of skirt portion 17. In other words, the outer surface of hard carbon film 22 covering chamfered portion 21 is located in alignment with outer peripheral surface 17a of skirt portion 17 in the axial direction of skirt portion 17, or located offset radially inwardly with respect to outer peripheral surface 17a of skirt portion 17 when viewed in the axial direction of skirt portion 17.

Film thickness W of DLC coating film 22 is set within a range of from 0.5 μm to 3.0 μm. In this embodiment, the film thickness W is set to about 1.0 μm.

### Method of Fabricating Valve Lifter

A method of fabricating valve lifter 11 according to this embodiment will be explained hereinafter. In a first step, a substrate of valve lifter 11 which is made of carbon steel is formed into an integral body by forging. The substrate includes skirt portion 17, disk-shaped crown portion 18 and boss portion 19 which are integrally formed.

Next, in a second step, chamfered portion 21 having an annular shape and the above-specified predetermined size (i.e., length L, taper angle θ and depth Z as shown in FIG. 3) is formed on an outer periphery of crown portion 18 adjacent to the outer peripheral edge of crown surface 20. That is, chamfered portion 21 is formed such that the length L is about 1 mm, the taper angle θ is about 26.5°, and the depth Z is about 0.5 mm, as described above.

Subsequently, in a third step, DLC coating film 22 is formed on crown surface 20 and chamfered portion 21 by a suitable surface treatment, for instance, arc ion plating.

Specifically, as shown in FIG. 6, carbon particles 22a as a film material are allowed to deposit toward crown surface 20 from a direction perpendicular to crown surface 20 as indicated by arrows. In this state, outer peripheral surface 17a of skirt portion 17 is substantially parallel with the direction of deposition of carbon particles 22a. Therefore, it is likely that DLC coating film 22 is nonuniformly formed on outer peripheral surface 17a.

For the above reason, in order to suppress deposition of carbon particles 22a onto outer peripheral surface 17a of skirt portion 17, the surface treatment is carried out by a masking jig (not shown) that is made of a suitable material such as rubber and configured to cover the whole outer peripheral surface of the substrate of valve lifter 11 except for crown surface 20, i.e., outer peripheral surface 17a of skirt portion 17 and an outer peripheral surface of crown portion 18. However, in order to enhance productivity, the masking jig is held in place with a fine clearance between outer peripheral surface 17a of skirt portion 17 and the outer peripheral surface of crown portion 18. As a result, as shown in FIG. 4 and FIG. 6, a slight amount of carbon particles 22a is allowed to enter the fine clearance and deposited on the outer peripheral surface of crown portion 18.

Subsequent to the third step, in a fourth step, as shown in FIG. 4, the whole area of outer peripheral surface 17a of skirt portion 17 as indicated by phantom line and the outer peripheral surface of crown portion 18 are subjected to finish-polishing with a given grind stone, thereby enhancing a dimensional accuracy of outer diameter d of skirt portion 17. Formation of valve lifter 11 is thus finished, so that there is provided valve lifter 11 having outer diameter d as shown in FIG. 5 which is conformed to inner diameter D of guide bore 16a of cylinder head 1.

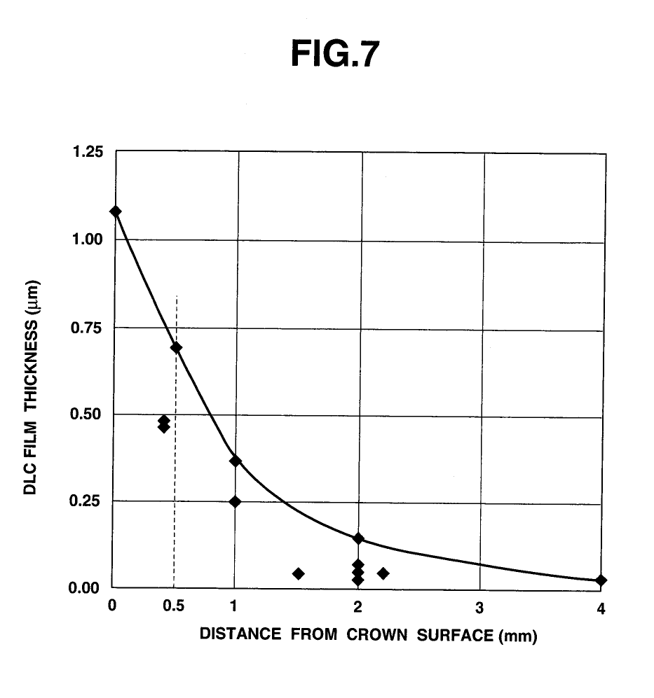

FIG. 7 is a graph showing results of measurement of thickness of peripheral portion 22b of DLC coating film 22 which is formed to cover chamfered portion 21 of crown portion 18 by arc ion plating when the thickness is measured while varying a distance from crown surface 20 to the measuring position in the axial direction of skirt portion 17.

Since only a slight amount of carbon particles are deposited on chamfered portion 21, it is difficult to measure a thickness of peripheral portion 22b of DLC coating film 22. In addition, in such a case, an error in measurement of the thickness of peripheral portion 22b tends to occur. Therefore, in FIG. 7, the thickness of peripheral portion 22b of DLC coating film 22 is expressed in terms of an amount of carbon (C) which is measured as a main component of DLC. In FIG. 7, axis of ordinates denotes thickness of peripheral portion 22b of DLC coating film 22, and axis of abscissas denotes distance from crown surface 20 up to the measuring position of the thickness of peripheral portion 22b toward the side of skirt portion 17 in the axial direction of skirt portion 17.

As seen from FIG. 7, the thickness of peripheral portion 22b of DLC coating film 22 (i.e., the C amount deposited on chamfered portion 21) is the maximum, i.e., about 1.00 μm in the vicinity of crown surface 20. As the distance from crown surface 20 toward the side of skirt portion 17 becomes larger, the thickness of peripheral portion 22b of DLC coating film 22 is reduced. For instance, when the distance from crown surface 20 is 0.5 mm, the thickness of peripheral portion 22b of DLC coating film 22 becomes about 0.7 μm. When the distance from crown surface 20 is 1 mm, the thickness of peripheral portion 22b of DLC coating film 22 becomes about 0.35 μm.

Generally, in the conventional valve lifter having a chamfered portion on an upper end portion thereof, an axial distance on the chamfered portion from the crown surface is within a range of from about 0.3 mm to about 0.5 mm. In FIG. 7, there is shown a characteristic curve showing a relationship between thickness of peripheral portion 22b of DLC coating film 22 and its distance from crown surface 20 in the axial direction of skirt portion 17. The characteristic curve is prepared by plotting maximum values of the thickness of peripheral portion 22b of DLC coating film 22 at each measuring position which are measured while varying a distance of the measurement position from crown surface 20. As indicated by the characteristic curve shown in FIG. 7, the thickness of peripheral portion 22b of DLC coating film 22 at the point where the distance from crown surface 20 is 0.5 mm is about 0.7 μm. In contrast, the thickness of peripheral portion 22b of DLC coating film 22 at the point where the distance from crown surface 20 is 1 mm is about 0.35 μm.

In order to thus reduce by half the thickness of peripheral portion 22b of DLC coating film 22 on chamfered portion 21 of crown portion 18, it is desired to set the length L of chamfered portion 21 to not less than 1 mm. In this embodiment, the length L of chamfered portion 21 is set to about 1 mm.

Further, it is possible to suppress deposition of carbon particles onto the outer peripheral surface of crown portion 18 by increasing the depth Z and the length L of chamfered portion 21. However, in a case where chamfered portion 21 is excessively expanded by increasing these parameters, reduction of a diameter of crown surface 20 or increase in outer diameter of skirt portion 17 will be caused to thereby adversely influence function of valve lifter 11.

In view of the above problems, in this embodiment, the depth Z and the length L of chamfered portion 21 are not changed, but the taper angle θ of chamfered portion 21 is set to 26.5°. As a result, taper angle θ of chamfered portion 21 is an acute angle with respect to outer peripheral surface 17a of skirt portion 17.

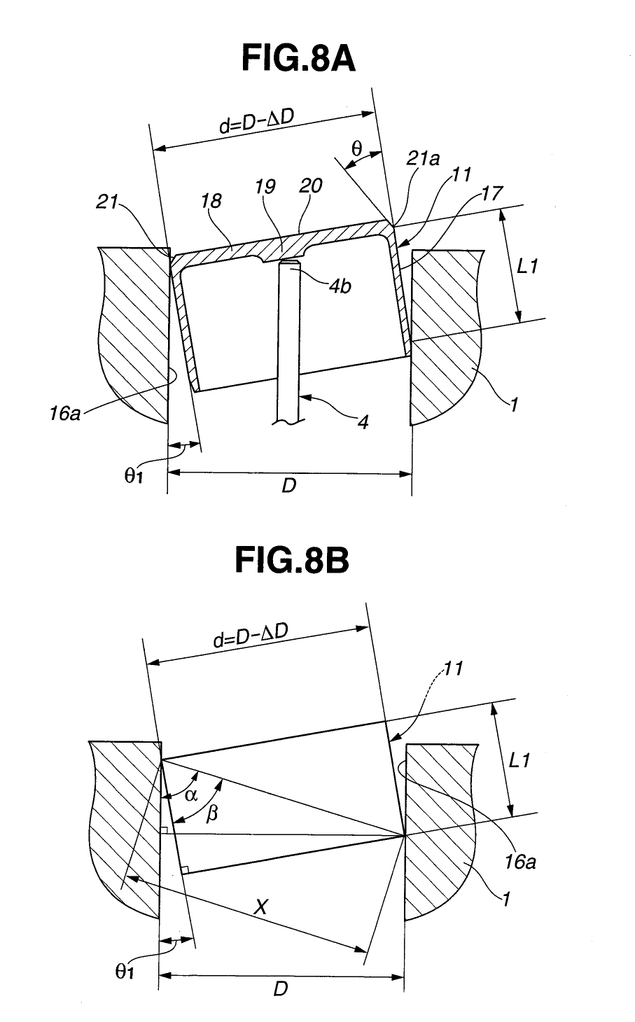

Specifically, as shown in FIG. 8A, when valve lifter 11 slides on the inner peripheral surface of guide bore 16a in the inclined state, lower end edge 21a of chamfered portion 21 is brought into slide contact with the inner peripheral surface of guide bore 16a to thereby reduce friction generated between valve lifter 11 and the inner peripheral surface of guide bore 16a. In this condition, in a case where the taper angle θ of chamfered portion 21 is smaller than inclination angle θ1 of valve lifter 11 with respect to the inner peripheral surface of guide bore 16a, a large friction is generated between valve lifter 11 and the inner peripheral surface of guide bore 16a similarly to the case of a valve lifter that is not formed with chamfered portion 21.

Accordingly, it is necessary to set a minimum taper angle θ of chamfered portion 21 to an angle with which an inherent friction reducing function of chamfered portion 21 can be attained. If the minimum taper angle θ is not smaller than a maximum inclination angle θ1 of valve lifter 11 with which valve lifter 11 can be slidably moved within guide bore 16a in an inclined state, chamfered portion 21 can attain the friction reducing function.

The maximum inclination angle θ1 of valve lifter 11 is determined on the basis of minimum value of inner diameter D of guide bore 16a, maximum value of clearance ΔD between the inner peripheral surface of guide bore 16a and the outer peripheral surface of valve lifter 11, and minimum value of axial length L1 of valve lifter 11 except for chamfered portion 21.

The maximum inclination angle θ1 of valve lifter 11 is calculated by the following expressions based on the relationship between inclination angle θ1 of valve lifter 11 within guide bore 16a and chamfered portion 21 of valve lifter 11 as shown in FIG. 8B.

α=tan⁻¹(d/L1)

β=sin⁻¹(D/X)=sin⁻¹D/√(L1²+d²)

θ1=β−α

In the above expressions, d denotes outer diameter of valve lifter 11 which is obtained by subtracting the clearance ΔD from the inner diameter D of guide bore 16a. For instance, under a condition that the inner diameter D of guide bore 16a is 20.0 mm at minimum, the axial length L1 of valve lifter 11 except for chamfered portion 21 is 10 mm at minimum, and the clearance ΔD is 0.1 mm at maximum, the maximum inclination angle θ1 of valve lifter 11 as calculated is smaller than 0.58°. Therefore, in this case, the minimum taper angle θ of chamfered portion 21 can be set to not smaller than 1° to thereby attain the friction reducing function of chamfered portion 21.

From the above viewpoint, in order to reduce by half the thickness of peripheral portion 22b of DLC coating film 22 without adverse influence on the function of valve lifter 11, it is desired to set the taper angle θ of chamfered portion 21 within a range of from 1° to 26.5°.

Further, in order to fulfill the above conditions, in this embodiment, the taper angle θ of chamfered portion 21 is set to 26.5°, and the length L of chamfered portion 21 is set to 1 mm. As a result, the depth Z extending between the outer peripheral edge of crown surface 20 and the plane P containing an extension line that extends from outer peripheral surface 17a of skirt portion 17 in the axial direction of skirt portion 17 becomes 0.5 mm.

Accordingly, in the fourth step as shown in FIG. 4, outer peripheral surface 17a of skirt portion 17 as indicated by phantom line and the outer peripheral surface of crown portion 18 are subjected to finish-polishing with a given grind stone, so that there can be provided valve lifter 11 as shown in FIG. 5 which has the respective outer peripheral surfaces polished with high accuracy. Further, during the polishing work, the grind stone can be held in non-contact with an outer surface of peripheral portion 22b of DLC coating film 22 which is formed on chamfered portion 21. That is, owing to the specific construction of chamfered portion 21, peripheral portion 22b of DLC coating film 22 which covers chamfered portion 21 is radially inwardly retracted so that peripheral portion 22b can be prevented from contact with the grind stone during the polishing work. Therefore, the whole area of the outer surface of peripheral portion 22b of DLC coating film 22 is a non-polished surface.

As a result, occurrence of partial wear of the grind stone can be suppressed to thereby increase life of the grind stone. Furthermore, it is possible to effectively avoid occurrence of clogging of the grind stone which is caused by powder of the hard carbon film polished, and therefore, suppress occurrence of a polishing defect.

The present invention is not limited to the above embodiment, and can also be applied to valve lifter 12 on the exhaust side.

Further, any other material except for DLC as an amorphous carbon material can be used for hard carbon film 22.

In addition, the valve lifter of the present invention can be applied to any other type of internal combustion engine which is different in piston displacement from that of the above embodiment.

This application is based on a prior Japanese Patent Application No. 2011-85956 filed on Apr. 8, 2011, the entire contents of which is hereby incorporated by reference.

Although the invention has been described above by reference to a certain embodiment of the invention, the invention is not limited to the embodiment described above. Modifications and variations of the embodiment described above will occur to those skilled in the art in light of the above teachings. The scope of the invention is defined with reference to the following claims.

What is claimed is:

1. A valve lifter of an internal combustion engine, comprising:
a cylindrical portion slidably moveable in a bore formed in the internal combustion engine;
a crown portion formed on one axial end portion of the cylindrical portion and integrally formed therewith, the crown portion having a crown surface that is contacted with a cam of the internal combustion engine,
a chamfered portion formed on an outer periphery of the crown portion adjacent to an outer peripheral edge of the crown surface, the chamfered portion being tapered toward the crown surface, and
a hard carbon film formed on the crown portion so as to cover only the crown surface and the chamfered portion;
wherein the chamfered portion has a taper angle with respect to an outer peripheral surface of the cylindrical portion on which the hard carbon film is not formed, the taper angle being set to not more than 26.5°, and
wherein the chamfered portion has a length extending from on a side of the crown surface toward a side of the cylindrical portion in an axial direction of the cylindrical portion, the length being set to not less than 1 mm.

2. The valve lifter as claimed in claim 1, wherein the taper angle of the chamfered portion is set to not less than 1°.

3. The valve lifter as claimed in claim 1, wherein the chamfered portion has a maximum depth on a side of the crown surface which extends outwardly in a radial direction of the crown surface, the maximum depth being set to not more than 0.5 mm.

4. The valve lifter as claimed in claim 1, wherein the hard carbon film has a thickness of 0.5 μm to 3.0 μm.

5. The valve lifter as claimed in claim 1, wherein the hard carbon film is a diamond-like carbon coating film.

6. A valve lifter of an internal combustion engine, comprising:
a cylindrical portion slidably moveable in a bore formed in the internal combustion engine;
a crown portion formed on one axial end portion of the cylindrical portion and integrally formed therewith, the crown portion having a crown surface that is contacted with a cam of the internal combustion engine,
a chamfered portion formed on an outer periphery of the crown portion adjacent to an outer peripheral edge of the crown surface, the chamfered portion being tapered toward the crown surface, and
a hard carbon film formed on the crown portion so as to cover only the crown surface and the chamfered portion;
wherein an outer peripheral surface of the hard carbon film covering the chamfered portion is located in a plane that contains an extension line extending from an outer peripheral surface of the cylindrical portion in an axial direction of the cylindrical portion, or located offset from the plane inwardly in a radial direction of the cylindrical portion, and
wherein the outer peripheral surface of the hard carbon film covering the chamfered portion is a non-polished surface.

7. The valve lifter as claimed in claim 6, wherein a whole area of the outer peripheral surface of the hard carbon film covering the chamfered portion is non-polished.

8. The valve lifter as claimed in claim 7, wherein the chamfered portion has a taper angle with respect to the outer peripheral surface of the cylindrical portion on which the hard carbon film is not formed, the taper angle being set to not more than 26.5°.

9. The valve lifter as claimed in claim 8, wherein the chamfered portion has a length extending toward a side of the cylindrical portion in the axial direction of the cylindrical portion, the length being set to not less than 1 mm.

10. The valve lifter as claimed in claim 9, wherein the chamfered portion has a maximum depth on a side of the crown surface which extends outwardly in a radial direction of the crown surface, the maximum depth being set to not more than 0.5 mm.

11. The valve lifter as claimed in claim 7, wherein the hard carbon film has a thickness of 0.5 μm to 3.0 μm.

12. The valve lifter as claimed in claim 7, wherein the hard carbon film is a diamond-like carbon coating film.

13. A method of fabricating a valve lifter of an internal combustion engine, the valve lifter including a cylindrical portion slidably moveable in a bore formed in the internal combustion engine, and a crown portion formed on one axial end portion of the cylindrical portion and integrally formed therewith, the crown portion having a crown surface that is contacted with a cam of the internal combustion engine, the method comprising the steps of:
after integrally forming the cylindrical portion and the crown portion, forming a chamfered portion on an outer periphery of the crown portion adjacent to an outer peripheral edge of the crown surface such that the chamfered portion has a taper angle of not more than 26.5° with respect to an outer peripheral surface of the cylindrical portion and a length of not less than 1 mm which extends toward a side of the cylindrical portion in an axial direction of the cylindrical portion;
forming a hard carbon film by allowing carbon particles to deposit toward the crown surface under a condition that the outer peripheral surface of the crown portion is covered with a masking jig; and
subjecting the outer peripheral surface of the cylindrical portion to polishing.

14. The method as claimed in claim 13, wherein the step of polishing the outer peripheral surface of the cylindrical portion is conducted with a grind stone.

15. The method as claimed in claim 14, wherein the grind stone is held in non-contact with at least an outer peripheral surface of the hard carbon film covering the chamfered portion during the step of polishing the outer peripheral surface of the cylindrical portion.

16. The method as claimed in claim 15, wherein the grind stone is held in non-contact with the hard carbon film during the step of polishing the outer peripheral surface of the cylindrical portion.
